(19) United States
(12) Patent Application Publication
(10) Pub. No.: US 2011/0215211 A1
(43) Pub. Date: Sep. 8, 2011

(54) APPARATUS AND METHOD FOR ATTACHING AN ACCESSORY TO A MOWER

(76) Inventor: Jason Wohlgemuth, Louisville, KY (US)

(21) Appl. No.: 12/718,828

(22) Filed: Mar. 5, 2010

(51) Int. Cl. F16M 13/00

(52) U.S. Cl. 248/219.2

(57) ABSTRACT

An accessory mount for self-propelled mowers allows accessories to be retrofitted to self-propelled mowers. Self-propelled mowers commonly have wheel assemblies mounted by vertically oriented stems held in vertical hollow tube wheel mounts. The end of the stems of the wheel assemblies extend out the top of the hollow tube wheel mounts, presenting hubs. Apertures in the hubs accept cotter pins for retaining the wheels. Washers at the top and bottom of the wheel assembly stems vertically position the wheels. An accessory mount has apertures sized and spaced to match the hubs and the cotter pins and washers used to retain the wheel assemblies also retain the accessory mount. The distance between apertures in the accessory mount can be adjusted to retrofit to different self-propelled mowers. The accessory mount presents interfaces such as bearing surfaces for interfacing with accessories.

### FIELD OF INVENTION

This invention relates to apparatus and methods of mounting accessories to mowers. In particular this invention relates to retrofit mounting of accessories to self-propelled mowers.

### BACKGROUND

Mowers are ubiquitous in lawn care and grounds keeping. Many of these mowers are self-propelled, some being walk-behind and some being riding lawn mowers. These mowers entail a substantial capital investment in that they have internal combustion engines on board, as well as transmissions, clutches, etc. As such, it is desirable to be able to find additional uses and applications for these mowers, as mowing is a fairly specialized and limited use for these capital investments. Additionally, these mowers are frequently used at sites where there is a high degree of physically demanding labor. Mowers that are self-propelled could provide platforms for labor saving accessories. In order to broaden their usage, these mowers need to have additional accessories mounted on them in addition to the mower deck, blades, etc. However, the mounting of these accessories should be simple and quick in order to facilitate the easy mounting and removal of accessories which will only be used part of the time. Additionally, the mounting should be easily adapted, or retrofitted, to existing self-propelled mowers.

Many of these mowers have multiple wheel assemblies attached by mounts on struts extending from the mower body or frame. These wheel assemblies usually have a fork spanning the axle of the wheel and a stem extending from the fork. The fork and stem of the wheel assembly are configured so that the axis of the stem does not intersect the axis of the wheel.

The wheel mounts consist of a strut extending from the body of the mower and a round vertically oriented tube on the end of the strut for receiving the stem of a wheel assembly. The stem passes all the way through the vertically oriented tube and produces an exposed hub at the top end of the tube. An aperture through the hub of the stem receives a cotter pin to maintain the wheel in the tube and mount. An abutment on the bottom of the stem rides against the bottom of the vertical tube. Spacers and washers can be placed on the stem between the bottom of the tube and the abutment to adjust the height at which the wheel carries the mower.

Since the axis of the stem does not intersect the axis of the wheel assembly, a wheel can easily reorient itself to align with the direction of movement of the stem in the mount. The wheel follows the stem. For mowers that are self-propelled, other wheels on the mower provide power and direction to the mower. The wheel assemblies that are free-turning only perform a load bearing purpose and support the weight of the mower deck, accessories, etc. Typically, these mowers have at least two of these wheel assemblies with stems mounted in vertical tubes.

### RELEVANT ART

U.S. Pat. No. 5,064,338 by Lawrence is for an “Implement Mounting Apparatus for Tractors and Mowers.” An implement mounting apparatus for use with utility tractors, lawn and garden tractors and riding front mowers and other vehicles which allows removable mounting and use of numerous attachments for performing multiple grounds maintenance, yard and lawn care or gardening functions. A support frame includes an upper member for positioning and a bottom member for supporting implements such as lift forks, a tool organizer, a work platform and housing body. The support frame is rigidly or pivotally mountable on a three-point hitch, a mounting/lift frame having a support strut, or a tow bar assembly. Wheels may be added for use of the apparatus with a tow bar as a trailer. The housing body is useful with a scraper blade as a plow, or may be easily converted to a hopper assembly or scoop by adding hopper or scoop members. The hopper assembly may be opened to dump contained material with a spring biased latch mechanism which may be locked closed. The scoop member is secured in position with the same latch mechanism.

U.S. Pat. No. 7,540,521 and U.S. Published Application 2009/0224509 are for “Tow-bar for wheel barrows”. In U.S. Pat. No. 7,540,521, a tow bar assembly for converting a two-wheeled wheelbarrow into a garden or industrial type trailer includes a bar of metal box tubing with horizontal holes at the wheelbarrow end and vertical holes at the tractor end. The wheelbarrow end is slid onto the axle of the wheelbarrow, keeping the bar between the tub of the wheelbarrow and its toe plate. Grommets positioned on the axle on either side of the bar center the tow bar assembly on the axle. A threaded post is inserted into the holes in the tractor end of the bar and locked into place by nuts. In use, the handles of the wheelbarrow are raised and the post inserted into the aperture of the tractor's draw bar from the underside of the aperture. The cantilevered weight of the wheelbarrow will keep the wheelbarrow from becoming disengaged from the garden tractor or towing vehicle. The legs of the wheelbarrow are kept off the ground and the trailer-barrow is now ready for use. Where the wheelbarrow conversion to a trailer is intended for heavy loads, a piece of flat iron is attached to the topside of the rails of the wheelbarrow close to its dumping end. In this way, when in use, the tow bar will rest on the flat iron instead of the wheelbarrow's toe bracket.

In U.S. Published Application 2009/0224509, a tow bar assembly for converting a two-wheeled wheelbarrow into a garden or industrial type trailer includes a bar of metal box tubing with horizontal holes at the wheelbarrow end and vertical holes at the tractor end. The wheelbarrow end is slid onto the axle of the wheelbarrow, keeping the bar between the tub of the wheelbarrow and its toe plate. Grommets positioned on the axle on either side of the bar center the tow bar assembly on the axle. A threaded post is inserted into the holes in the tractor end of the bar and locked into place by nuts. In use, the handles of the wheelbarrow are raised and the post inserted into the aperture of the tractor's draw bar from the underside of the aperture. The cantilevered weight of the wheelbarrow will keep the wheelbarrow from becoming disengaged from the garden tractor or towing vehicle. The legs of the wheelbarrow are kept off the ground and the trailer-barrow is now ready for use. Especially where the wheelbarrow conversion to a trailer is intended for heavy loads, a piece of flat iron is attached to the top-side of the rails of the wheelbarrow close to its dumping end. In this way, when in use, the tow bar will rest on the flat iron instead of the wheelbarrow's toe bracket. In a preferred embodiment the bar is PVC piping and a piece of flat iron is riveted to the bar, parallel to same so that in use the flat iron rests on the toe plate.

U.S. Pat. No. 5,509,681 is for a “Kit and method for converting a wheel barrow into a garden cart”. A kit for converting a wheelbarrow for use as a towed garden cart is especially suited for wheelbarrows of the type comprising a pan supported on diverging beams, and a brace between forward ends of the beams, a forward wheel mounted to the beams adjacent the brace and a pair of depending legs mourned to the beams behind the forward wheel. The kit comprises rear wheel assemblies mounted to each of the depending legs and a front hitch plate releasably attached to the forward ends of the beams adjacent the brace and having a forwardly extending tongue adapted to connect to a hitch on a towing vehicle. The hitch plate has a riser received behind the brace and a return flange forming a channel to receive laterally extending support members which rest atop the beam forward ends. The rear wheel assembly preferably comprises an axle tube adapted to mount to each of the rear legs and axles bearing wheels releasably mounted within each of the axle tubes.

### SUMMARY OF EMBODIMENTS OF THE INVENTION

Embodiments of the present invention utilize the exposed hubs of stems on wheel assemblies on lawnmowers to locate implement accessory mounts. Some of these lawn mowers are self-propelled. Some embodiments of the apparatus to facilitate the mounting of accessories comprises a mounting structure having an aperture for each stem of a wheel assembly with which it will be interfacing. In embodiments utilizing two wheel assemblies, the mount, or adaptor, will have two apertures spaced and size to fit over the exposed upper hubs of the wheel assembly stems. In one embodiment, the accessory mount is comprised of a shaft having apertures at each end with the apertures being internally threaded. A coupler having externally threaded studs is threaded into each aperture, each coupler having an aperture sized to fit over the exposed hub of the stem of the wheel assembly. The couplers may be adjusted inwardly or outwardly by turning them about the shaft axis, thus moving the couplers with the threaded interfaces. This will allow the adaptor to accommodate wheel assemblies that are different distances apart. Other embodiments of the accessory mount may use at least one sliding member to provide the capability to adjust widths between the apertures.

After mounting on the stems of the wheel assemblies, the accessory mount will carry, or present, interfaces for accessories. In one embodiment, the mount will present a round outer surface to act as a bearing for rotational interface with accessories. Once an accessory attaches to the mount, it can rotate about the bearing surface presented by the accessory mount. In embodiments for wheelbarrow hoppers, a receiver on the wheelbarrow hopper will pass over the bearing surface on the accessory mount and the accessory mount is then attached to the mower by placing the apertures over respective wheel assembly stem hubs and washers and cotter pins put in place to secure the mount and accessory, or hopper. The hopper is thereby mounted to the mower and can be tipped by rotating it about the bearing surface presented by the accessory mount. In other embodiments, a shaft on the accessory mount may be sized to fit through the apertures on a wheelbarrow where a wheel shaft would normally be located. This provides an extremely easy adaptation of a wheelbarrow hopper to be carried upon the lawnmower.

### BRIEF DESCRIPTION OF DRAWINGS

Additional utility and features of the invention will become more fully apparent to those skilled in the art by reference to the following drawings, which illustrate some of the primary features of embodiments.

FIG. 1 is a perspective view of the accessory mount located on the mower with an accessory mounted on it.

FIG. 2 is a perspective view of a mower without the accessory mount or accessory.

FIG. 3 is a perspective view of a mower with the accessory mount only on the mower.

FIG. 4 is a perspective view of an embodiment of an accessory mount apart from the mower.

FIG. 5 is a perspective view of another embodiment of an accessory mount apart from the mower.

FIG. 6 is an exploded assembly view of an accessory mount and the wheel mounts and wheel assemblies of a mower.

FIG. 7 is a perspective view of a wheel barrow hopper mounted on a mower with an embodiment of an accessory mount and turned up to an emptying position.

FIG. 8 is a perspective view of a converted manual wheelbarrow mounted on a mower with an embodiment of an accessory mount.

### DETAILED DESCRIPTION OF EMBODIMENTS OF THE INVENTION

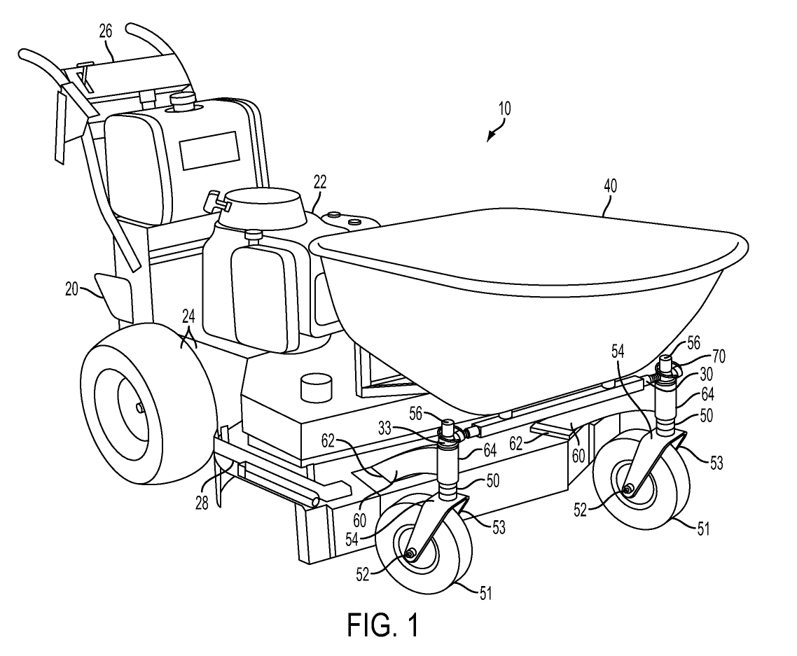

FIG. 1 shows an assembly 10 of a self-propelled mower 20, an accessory mount 30, and an accessory 40. Mower 20 is comprised of, among other things, a power plant 22, transmission and drive wheels 24, handle bars and controls 26, mower deck, 28, and wheel assemblies 50. Wheel assemblies 50 do not provide any drive to self-propelled mower 20, but rather only provide load bearing functions.

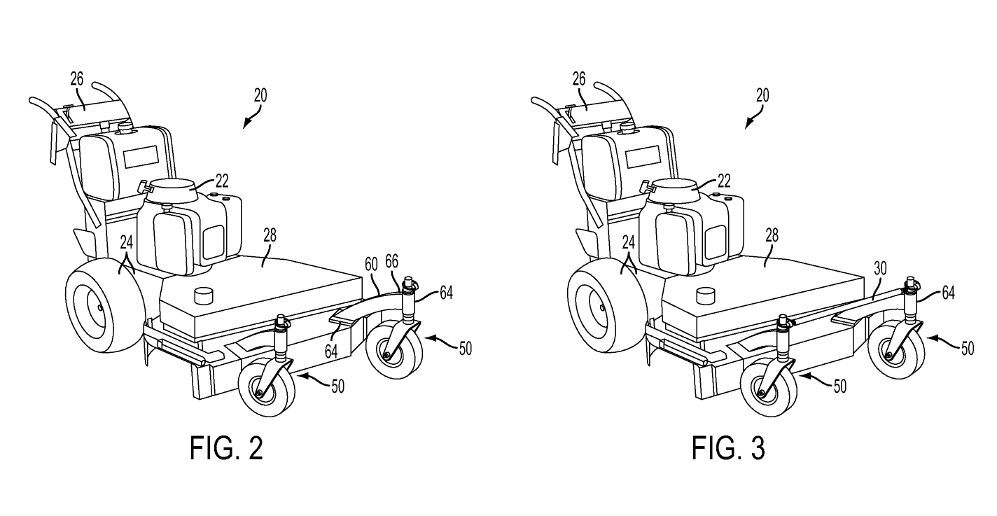

FIG. 2 shows a self-propelled mower 20 like that shown in FIG. 1, but without an accessory mount and accessory attached. In FIG. 2, wheel assemblies 50 are more prominently visible. Extending from the front of mower deck 28 of self-propelled mower 20 are wheel mount struts 60. Wheel mount struts 60 attach at a base end 62 to mower deck 28 and have a vertically oriented bearing tube 64 attached to its extended end 66. Wheel assemblies 50 mount in vertically oriented bearing tubes 64.

FIG. 6 shows wheel assemblies 50, mounting struts 60, bearing tubes 64, accessory mount 30, and other elements in an exploded assembly view in perspective. More details of wheel assemblies 50 may be seen in FIG. 6. Wheel assemblies 50 are comprised of wheels 51 which have their axles 52 straddled by forks 53. Forks 53 are curved up from axles 52 to present a base 54 generally offset from axles 52 of wheels 51. A stem 55 extends from base 54 opposite to fork 53 and stem 55 is perpendicularly skewed from axle 53, i.e. if the axis of stem 55 were to intersect the axle 52 of wheel 51, they would be perpendicular. Stem 55 is sized to fit in vertically oriented bearing tube 64. At the base of stem 55 is seat 58 on which bearing tube 64 and spacers 80 rest. Stem 55 is long enough that it protrudes from the top end of bearing tube 64 and presents a hub 56 protruding from bearing tube 64. A retainer aperture 57 passes through hub 56, allowing a cotter pin 70 to be inserted through hub 56 to prevent wheel assembly 50 from dropping out when mower deck 28 lifts to a certain height. Spacers 80 may be employed on stem 55 above and below bearing tube 64 to adjust the height at which wheel assemblies 50 support mower deck 28.

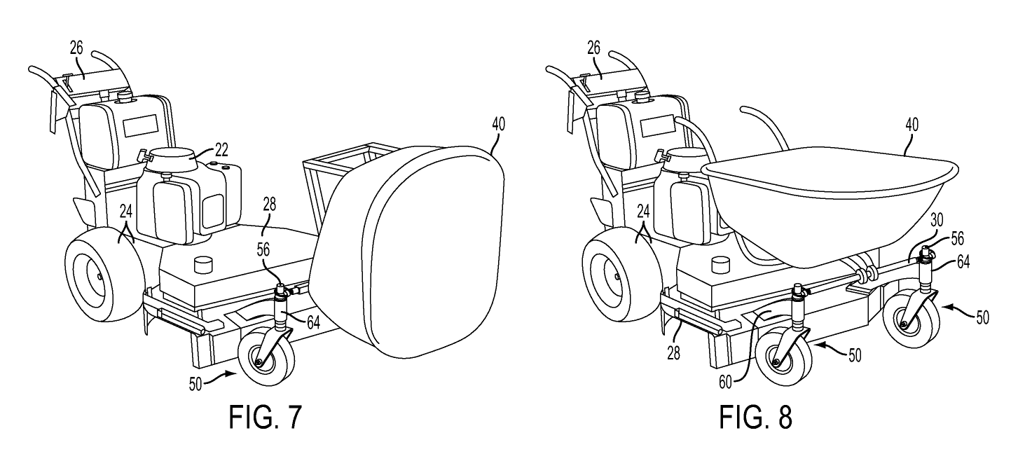

FIG. 3 shows an embodiment of accessory mount 30 attached to self-propelled mower 20. Accessory mount 30 spans between two forward wheel assemblies 50 and attaches over hubs 56 of those wheel assemblies 50. Accessory mount 30 is retained on mower 20 by cotter pins 70 and washers 80. This may also be seen in FIG. 6. In the embodiment shown in FIG. 3, accessory mount 30 presents a round outer surface which acts as a bearing surface 99 for accessories to interface with. FIG. 1 shows a mounting member 42 on the accessory 40 fitting over accessory mount 30 and accessory 40 in a first position. In the embodiment of FIG. 1, the accessory is a hopper. FIG. 7 shows the accessory 40 rotated about accessory mount 30 to a second position. This allows accessory 40 to remain attached while being reoriented during use. In the embodiment shown in FIG. 1 and FIG. 7, accessory 40 is a hopper moved from carrying position to an emptying position. Many manual wheelbarrows have hoppers easily separated from their frames. Some embodiments of the present invention readily accommodate frames adapted to accept hoppers from manual wheelbarrows.

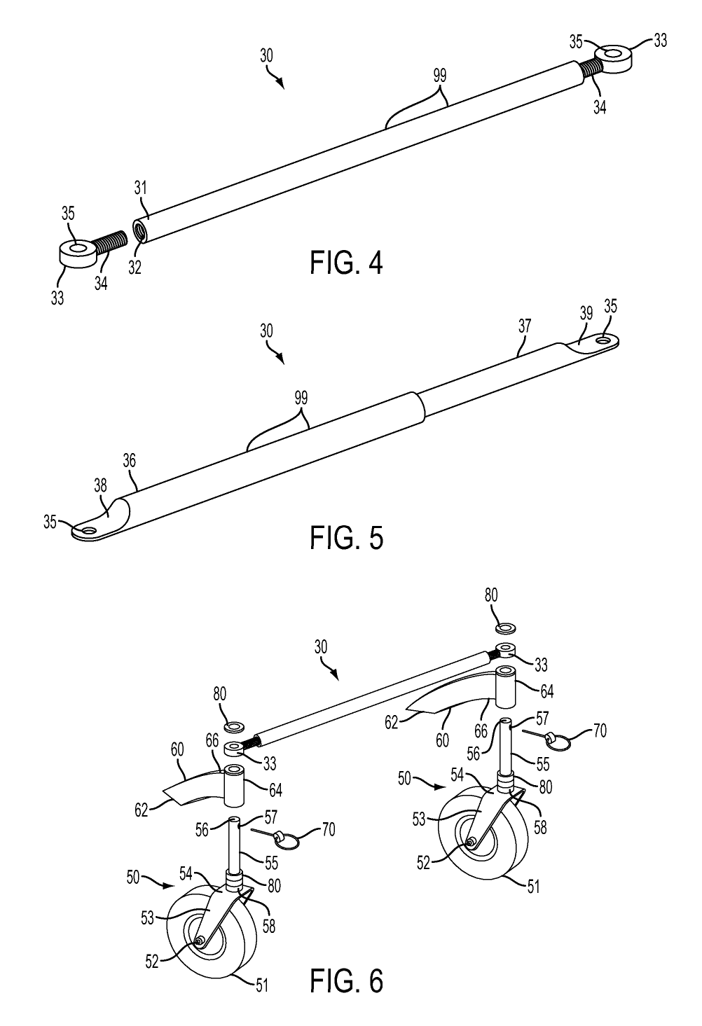

FIG. 4 shows an embodiment of accessory mount 30. In this embodiment, accessory mount 30 has a central shaft 31 which has at each end a threaded aperture 32. Couplers 33 have threaded studs 34 matching threaded apertures 32. Threaded studs 34 of couplers 33 are threaded into threaded apertures 32 of central shaft 31. Mount apertures 35 in couplers 33 are sized to fit over hubs 56 extending from bearing tubes 64. The distance between mount apertures 35 may be adjusted for different mowers 20 by screwing couplers 33 further in or out. Central shaft 31 of accessory mount 30 in FIG. 4 presents a round outer surface which acts as a bearing surface 99 for accessories to interface with.

FIG. 5 shows an embodiment of accessory mount 30 which employs two sliding members. A mostly hollow outer sliding member 36 receives an inner sliding member 37. The exposed end 38 of outer sliding member 36 and the exposed end 39 of inner sliding member 37 are closed with mount apertures 35 passing through them. Mount apertures 35 are sized to fit over hubs 56 and the distance between mount apertures 35 may be changed by sliding inner sliding member 37 in or out with respect to outer sliding member 36. Outer sliding member 36 of accessory mount 30 in FIG. 5 presents a round outer surface which acts as a bearing surface 99 for accessories to interface with. In some embodiments, mount apertures 35 may pass through outer sliding member 36 and inner sliding member 37 without closing off their exposed ends 38, 39.

FIG. 8 shows another embodiment of an assembly 10 of self-propelled mower 20, accessory mount 30 and accessory 40. In the embodiment of FIG. 8, accessory 40 is a converted manual wheelbarrow 90 with its wheel removed. The accessory mount 30 interfaces with manual wheelbarrow 90 where the axle of the wheel would be. The wheelbarrow can rotate about the accessory mount 30 to move from a carrying position to an emptying position. This embodiment retrofits a hopper accessory to self-propelled mower with minimal changes to a manual wheelbarrow 90.

It is to be understood that the embodiments and claims are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

I claim:

1. A retrofit accessory mount for a mower comprising:
a first member having a first aperture sized to fit over a hub of a stem of a first wheel assembly on a mower;
a second member attached to said first member, said second member having a second aperture sized to fit over a hub of a stem of a second wheel assembly on said self-propelled mower;
said first aperture and said second aperture being oriented and spaced with respect to each other to match the space and orientation of the hubs on the stems of said first and second wheel assemblies.

2. The retrofit accessory mount for a mower of claim 1 wherein:
said accessory mount presents at least one bearing outer diameter for rotational coupling to an accessory.

3. The retrofit accessory mount for a mower of claim 1 wherein:
said retrofit accessory mount is retained over said first and second hubs by cotter pins and washers.

4. The retrofit accessory mount for a mower of claim 1 wherein:
the distance between said first and second apertures is adjustable.

5. The retrofit accessory mount for a mower of claim 4 wherein:
said second member comprises a shaft having at least one internally threaded aperture, and;
said first member comprises a first coupling having a shaft threaded to couple to said at least one internally threaded aperture of said second member, said first coupling having said first aperture.

6. The retrofit accessory mount for a mower of claim 5 wherein:
said second member comprises an additional internally threaded aperture in addition to the internally threaded aperture coupled to by said first coupling, and;
said second member further comprises a second coupling having a shaft threaded to couple to said additional internally threaded aperture, said second coupling having said second aperture.

7. The retrofit accessory mount for a mower of claim 4 wherein:
said first member and said second member are slidably engaged with each other.

8. The retrofit accessory mount for a mower of claim 1 further comprising:
an accessory.

9. The retrofit accessory mount for a mower of claim 8 wherein:
said accessory comprises a rotatable bin.

10. The retrofit accessory mount for a mower of claim 8 wherein:
said rotatable bin comprises a converted manual wheelbarrow.

11. A mower having an accessory mount comprising;
a mower having;
a first wheel mount strut extending from said mower, said first wheel mount strut being attached to the body of said mower and having an extended end extended away from the body of said mower;
a first wheel mount on the extended end of said first wheel mount strut, said first wheel mount comprising a first bearing tube oriented with its axis essentially vertical;
a first wheel assembly mounted in said first wheel mount, said first wheel assembly having a stem, said stem of said first wheel assembly passing though said bearing tube and having a first hub extending from the top end of said first bearing tube, and;
a second wheel mount strut extending from said mower, said second wheel mount strut being attached to the body of said mower and having an extended end extended away from the body of said mower;
a second wheel mount on the extended end of said second wheel mount strut, said second wheel mount comprising a second bearing tube oriented with its axis essentially vertical;
a second wheel assembly mounted in said second wheel mount, said second wheel assembly having a stem, said stem of said second wheel assembly passing though said bearing tube and having a second hub extending from the top end of said second bearing tube, and;
said mower further having an accessory mount, said accessory mount spanning from said first hub to said second hub.

12. The mower having an accessory mount of claim 11 wherein;
said accessory mount presents at least one bearing outer diameter for rotational coupling to an accessory.

13. The mower having an accessory mount of claim 11 wherein;
said accessory mount has a first aperture sized to fit over said first hub and a second aperture sized to fit over said second hub, said first and second apertures being oriented and spaced with respect to each other so that said first and second apertures fit over their respective hubs.

14. The mower having an accessory mount of claim 13 wherein;
said accessory mount is retained over said first and second hubs by cotter pins and washers.

15. The mower having an accessory mount of claim 13 wherein;
the distance between said first and second apertures is adjustable.

16. The mower having an accessory mount of claim 15 wherein;
said accessory mount comprises;
at least one internally threaded aperture, and;
at least one coupling having a threaded stud to couple to said at least one internally threaded aperture, said at least one coupling having either said first or said second aperture of said accessory mount.

17. The mower having an accessory mount of claim 15 wherein;
said accessory mount comprises at least one sliding member, said at least one sliding member carrying either said first or said second aperture.

18. The mower having an accessory mount of claim 11 further comprising;
an accessory mounted to said accessory mount.

19. The mower having an accessory mount of claim 18 wherein;
said accessory comprises a rotatable bin.

20. The mower having an accessory mount of claim 19 wherein;
said rotatable bin comprises a converted manual wheelbarrow.
